(19) United States
(12) Patent Application Publication
(10) Pub. No.: US 2018/0055232 A1
(43) Pub. Date: Mar. 1, 2018

(54) WEATHERPROOF WHEELCHAIR COVER

(71) Applicant: ATTOY K. DENOBRIGA, Bronx, NY (US)

(72) Inventor: ATTOY K. DENOBRIGA, Bronx, NY (US)

(21) Appl. No.: 15/253,888

(22) Filed: Sep. 1, 2016

(51) Int. Cl. A47C 7/66; A47C 31/11; A61G 5/10

(52) U.S. Cl. CPC A47C 7/66; A61G 5/10; A47C 31/113

(57) ABSTRACT

A weatherproof wheelchair cover system for enabling users mobility during adverse weather systems. The weatherproof wheelchair cover system includes a removably attachable weatherproof wheelchair cover assembly that includes a combination shield/cover, an attachment assembly, at least one support frame, a hinged pivot connector, and a joystick in functional combination The combination shield/cover includes weatherproof surfaces and weatherproof viewing apertures. The preferred embodiment includes a combination vent flap/upper viewing aperture that can be closed to protect the user or opened while the wheelchair cover assembly is in a deployed state. The weatherproof wheelchair cover system is deployable for use while having the ability to be retracted for situations where the weather is favorable or the wheel chair is operated indoors. The weatherproof wheelchair cover system is removably coupleable from the wheelchair and can be stored for period of nonuse.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of removably attached to wheel chair and more specifically relates to weatherproof wheelchair cover systems.

### 2. Description of Related Art

A wheelchair is a chair with wheels. Many individuals use wheelchairs. The device comes in variations allowing either manual propulsion by the seated occupant turning the rear wheels by hand, or electric propulsion by motors. There are often handles behind the seat to allow it to be pushed by another person. Wheelchairs are used by people for whom walking is difficult or impossible due to illness, injury, or disability. People who have difficulty sitting and walking often make use of a wheelbench. Users of wheelchairs are not protected against snow and rain; against sun damage to the user's skin in adverse outside weather. A suitable solution is desired.

Several attempts have been made to solve the above-mentioned problems such as those found in U.S. Pat. No. 6,659,211 to Esposito, U.S. Pat. No. 5,322,408 to Wooden, U.S. Pat. No. 6,769,160 to Taylor Nash, Pat. No. JP2004318552 to Tokuo Matsuoka, U.S. Pub No. 2008/0224504 to Fargason. This art is representative of wheel chairs and accessories. However, none of the above inventions and patents, taken either singly or in combination, is seen to describe the invention as claimed.

Preferably, a weatherproof wheelchair cover system should provide protection from weather conditions and, yet would operate reliably and be manufactured at a modest expense. Thus, a need exists for a reliable weatherproof wheelchair cover system to avoid the above-mentioned problems.

### BRIEF SUMMARY OF THE INVENTION

In view of the foregoing disadvantages inherent in the known wheelchair art, the present invention provides a novel weatherproof wheelchair cover system. The general purpose of the present invention, which will be described subsequently in greater detail, is to provide a weatherproof wheelchair cover system.

A weatherproof wheelchair cover system is disclosed herein, in a preferred embodiment, comprising a weatherproof wheelchair cover assembly. In the preferred embodiment the wheelchair cover assembly may comprise a combination shield/cover, an attachment assembly, at least one support frame, a hinged pivot connector, and a joystick. The combination shield/cover may comprise a top surface, a right side surface, a left side surface, a back surface, a right viewing aperture a left viewing aperture, a support frame sleeve, a combination vent flap/upper viewing aperture, a second attachment hook and loop strap, and a lower viewing aperture. The right viewing aperture may comprise at least one support rib. The left viewing aperture may comprise at least one support rib. The combination vent flap/upper viewing aperture may comprise a hinged viewing aperture and a first attachment hook and loop strap.

In the preferred embodiment the weatherproof wheelchair cover assembly further may comprise a motor/cable spool attachment member, a motor, a cable, a cable feed/frame coupler, a cable spool, and a cable cover connector. The cable feed/frame coupler further may comprise a cable feed opening.

The preferred embodiment of the weatherproof wheelchair cover system further may comprise a kit including: a weatherproof wheelchair assembly and a set of user instructions.

Also disclosed, in a preferred embodiment, is a method of using a weatherproof wheelchair cover system the steps of which comprise: obtaining the weatherproof wheelchair cover system, mounting the weatherproof wheelchair cover assembly, connecting the weatherproof wheelchair cover assembly, and deploying the weatherproof wheelchair cover assembly. Additional steps of the preferred method include: retracting the weatherproof wheelchair cover assembly, removing the weatherproof wheelchair cover assembly, and storing the weatherproof wheelchair cover assembly.

The present invention holds significant improvements and serves as a weatherproof wheelchair cover assembly. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, weatherproof wheelchair cover system, constructed and operative according to the teachings of the present invention.

FIG. 1 shows a perspective view illustrating a weatherproof wheelchair cover system during an ‘in-use’ condition showing a user protected from environmental elements according to an embodiment of the present invention.

FIG. 2 is a perspective view illustrating the weatherproof wheelchair cover system comprising a weatherproof wheelchair cover assembly according to an embodiment of the present invention of FIG. 1.

FIG. 3A is a perspective cross sectional view illustrating the weatherproof wheelchair cover assembly according to an embodiment of the present invention.

FIG. 3B is a perspective front view embodiment of the present illustrating the internal structure of a weatherproof wheelchair cover assembly according to an invention of FIGS. 1-2.

FIG. 4A is a perspective view illustrating weatherproof wheelchair cover assembly according to an embodiment of the present invention of FIGS. 1-3B with the additional feature of a motor powered cable lift mechanism.

FIG. 4B is a perspective cross sectional view illustrating weatherproof wheelchair cover assembly according to an embodiment of the present invention of FIG. 4A.

FIG. 4C is a perspective front view illustrating weatherproof wheelchair cover assembly according to an embodiment of the present invention of FIGS. 1-3B.

FIG. 5 is a flowchart illustrating a method of use for the weatherproof wheelchair cover system according to an embodiment of the present invention of FIGS. 1-4C.

The various embodiments of the present invention will hereinafter be described in conjunction with the appended drawings, wherein like designations denote like elements.

### DETAILED DESCRIPTION

As discussed above, embodiments of the present invention relate to a weatherproof wheelchair cover system and more particularly to a weatherproof wheelchair cover assembly as used to improve the ability to use a wheelchair for mobility during adverse weather conditions.

Generally speaking, a weatherproof wheelchair cover system may comprise a weatherproof wheelchair cover assembly. Weatherproof wheelchair cover system may be structured and arranged to provide a user with the ability to use a wheelchair for mobility during adverse weather conditions.

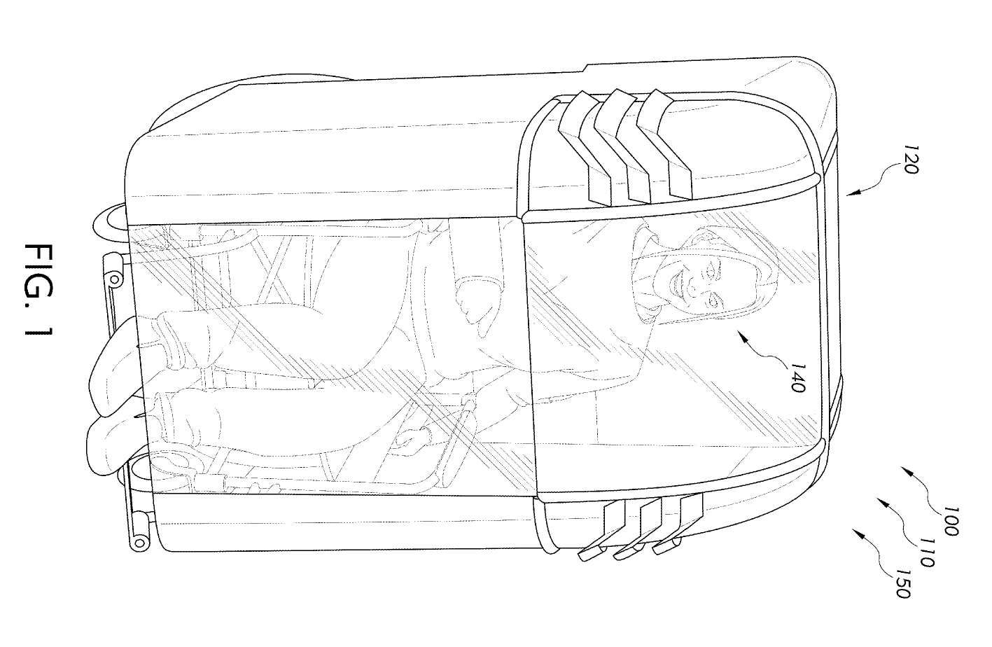

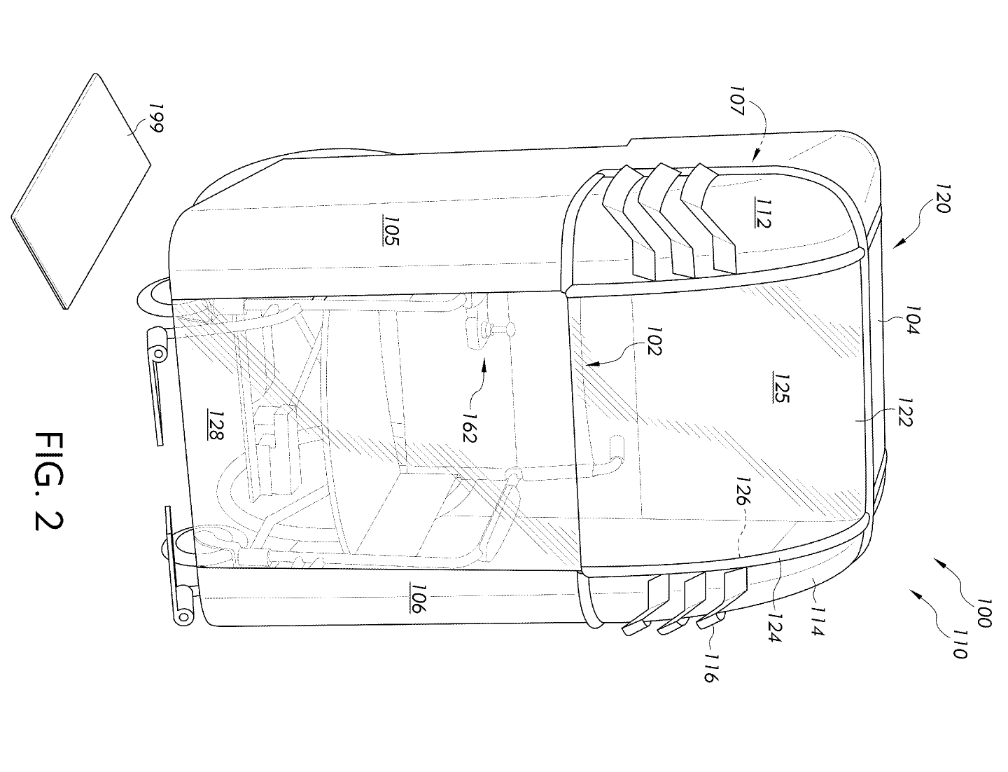

Referring to the drawings by numerals of reference there is shown in FIGS. 1-4C a weatherproof wheelchair cover system 100 comprising a weatherproof wheelchair cover assembly 110 is shown during an ‘in-use’ condition 150 whereas the user 140 is shielded by the combination shield/cover 120 while using the wheelchair 102.

Referring now to FIGS. 1-3B showing a weatherproof wheelchair cover assembly 110 comprising a combination shield/cover 120, an attachment assembly 130, at least one support frame 192, and a plurality of hinged pivot connectors 172. The combination shield/cover 120 may comprise a support frame sleeve 118 for attaching to the at least one support frame 192. The combination shield/cover 120 may comprise a top surface 104, a right side surface 105, a left side surface 106, back surface 107, a right viewing aperture 112, a left viewing aperture 114, a support frame sleeve 118, a combination vent flap/upper viewing aperture 122, a second attachment hook and loop strap 126, and a lower viewing aperture 128. The right viewing aperture 112 may comprise at least one support rib 116. The left viewing aperture 114 may comprise at least one support rib 116. The combination vent flap/upper viewing aperture 122 may comprise a hinged viewing aperture 125. The hinged viewing aperture 125 may comprise a first attachment hook and loop strap 124.

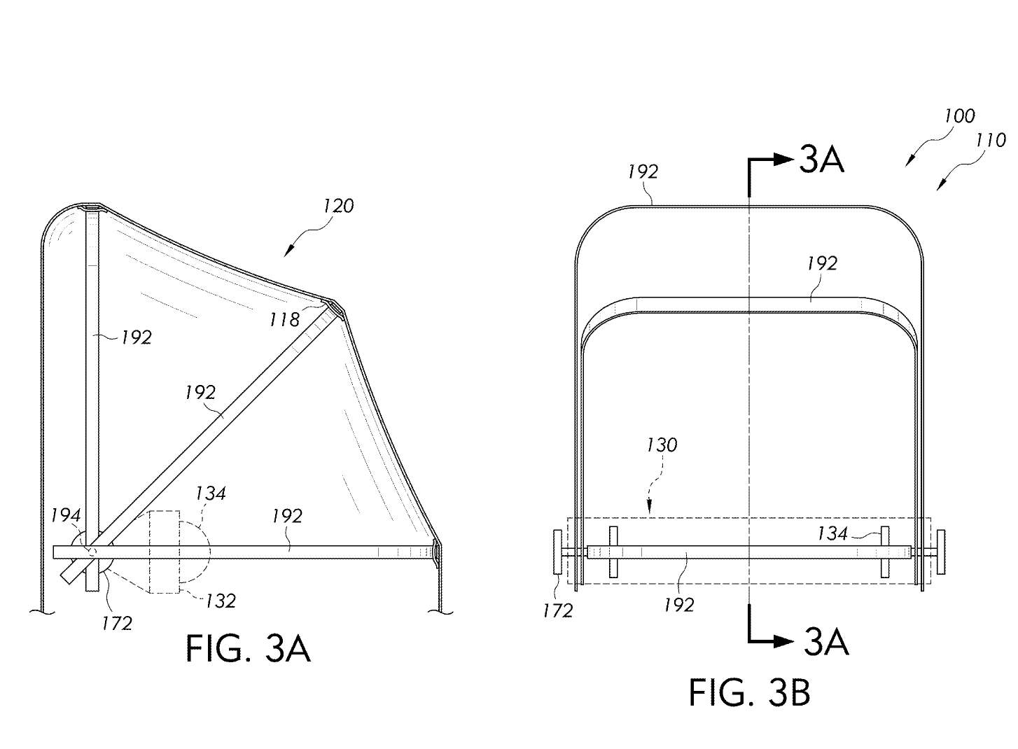

Referring now to FIG. 3A attachment assembly 130 is shown comprising a removably couplable attachment mechanism 134. The weatherproof wheelchair cover assembly 110 may further be comprised of a plurality of hinged attachment members 132 and at least one support frame that may comprise a hinged attachment opening 194.

In distinct embodiments combination shield/cover 120 top surface 104, right side surface 105, left side surface 106, and back surface 107 may be constructed of a weatherproof material such as canvas.

In distinct embodiments weatherproof wheelchair cover assembly 110 right viewing aperture 112, left viewing aperture 114, hinged viewing aperture 125, and lower viewing aperture 128 may be made of a weatherproof transparent material.

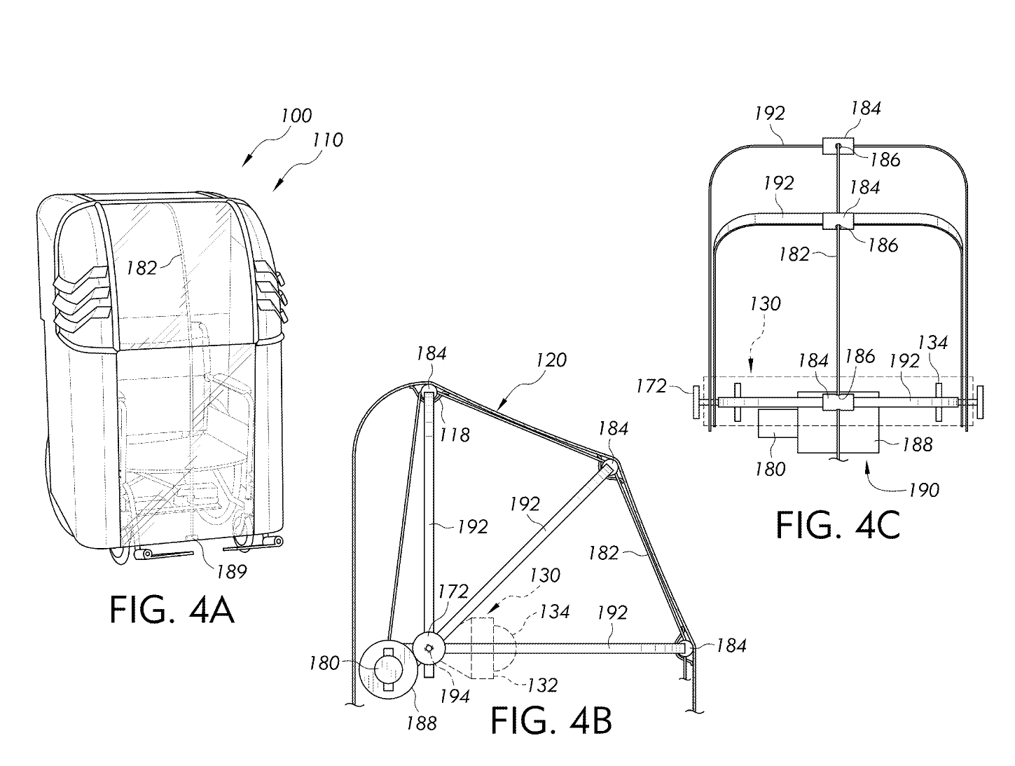

Referring now to FIGS. 4A-4C, further embodiments of weatherproof wheelchair cover assembly 110 may include at least one support frame 192 that may be electrically controlled where electrical control may be powered by a motor 180 attached to attachment assembly 130 via motor/cable spool attachment member 190.

In certain embodiments of the weatherproof wheelchair cover assembly 110 the motor 180 may power a cable spool 188 and cable 182 whereas the cable 182 is fed through at least one cable feed/frame coupler 184 through cable feed opening 186 and attached at its distal end to cable cover connector 189. Weatherproof wheelchair cover system 110 may use the motor 180 to turn cable spool 188 and unwind cable 182 to deploy and retract at least one support frame 192 and combination shield/cover 120.

Some embodiments of the weatherproof wheelchair cover assembly 110 may use wheelchair's power source. Other embodiments of the weatherproof wheelchair cover assembly 110 may use a separate power source. Further embodiments of weatherproof wheelchair cover assembly 110 may use a solar power source.

The weatherproof wheelchair cover assembly 110 motor 180 may be activated using a joystick 162. Some embodiments of weatherproof wheelchair cover assembly 110 may use activate the motor 180 using a button switch.

It should be noted that weatherproof wheelchair cover systems system 100 may be sold as kit 440 comprising the following parts: at least one weatherproof wheelchair cover assembly 110 and at least one set of user instructions 199. The kit has instructions such that functional relationships are detailed in relation to the structure of the invention (such that the invention can be used, maintained, or the like in a preferred manner). Weatherproof wheelchair cover system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different powering and weather sheilding combinations, parts may be sold separately, etc., may be sufficient.

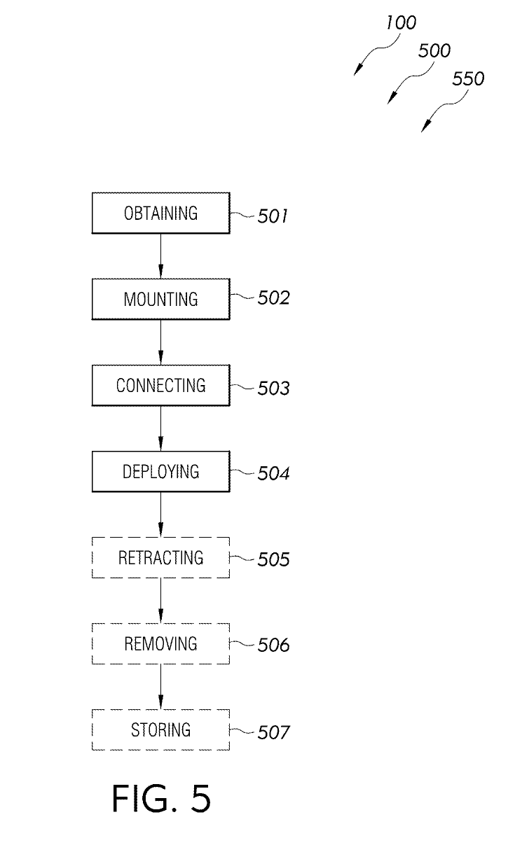

Referring now to FIG. 5 showing flowchart 550 illustrating method of use 500 for weatherproof wheelchair cover system 100 according to an embodiment of the present invention of FIGS. 1-3C. As shown, method of use 500 may comprise the steps of: step one 501, obtaining a weatherproof wheelchair cover assembly 110; step two 502, mounting a weatherproof wheelchair cover assembly 110; step three 503, connecting weatherproof wheelchair cover assembly 110; step four 504, deploying weatherproof wheelchair cover assembly 110; step five 505 retracting weatherproof wheelchair cover assembly 110; step six 506, removing weatherproof wheelchair cover assembly 110; and step seven 507, storing weatherproof wheelchair cover assembly 110.

It should be noted that step five 505, step six 506, and step seven 507 are optional steps and may not be implemented in all cases. Optional steps of method of use 500 are illustrated using dotted lines in FIG. 5 so as to distinguish them from the other steps of method of use 500.

It should be noted that the steps described in the method of use can be carried out in many different orders according to user preference. The use of “step of” should not be interpreted as “step for”, in the claims herein and is not intended to invoke the provisions of 35 U.S.C. §112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A weatherproof wheelchair cover system comprising:
a weatherproof wheelchair cover assembly comprising;
a combination shield/cover comprising;
a top surface;
a right side surface;
a left side surface;
a back surface;
a right viewing aperture comprising:
at least one right-support rib;
a left viewing aperture comprising:
at least one left-support rib;
a support frame sleeve;
a combination vent flap/upper viewing aperture comprising:
a hinged viewing aperture;
a first attachment hook and loop strap;
a second attachment hook and loop strap;
a lower viewing aperture;
an attachment assembly comprising:
a hinged attachment member;
a removably couplable attachment mechanism;
at least one support frame comprising:
a hinged attachment opening; and
a hinged pivot connector;
wherein said weatherproof wheelchair cover system comprises said weatherproof wheelchair cover assembly;
wherein said weatherproof wheelchair cover assembly comprises said combination shield/cover, said attachment assembly, said at least one support frame, and plurality of hinged pivot connectors in functional combination;
wherein said combination shield/cover is defined by said top surface, said right side surface, said left side surface, said back surface; said right viewing aperture said left viewing aperture, said support frame sleeve, said combination vent flap/upper viewing aperture, said second attachment hook and loop strap, and said lower viewing aperture in functional combination;
wherein said combination vent flap/upper viewing aperture comprises said hinged viewing aperture and said first attachment hook and loop strap in functional combination; and
wherein said attachment assembly comprises said hinged attachment member and said removably couplable attachment mechanism in functional combination.

2. The weatherproof wheelchair cover system of claim 1 wherein said top surface, said right side surface, said left side surface, and said back surface are to be constructed of a weatherproof material.

3. The weatherproof wheelchair cover system of claim 2 wherein said weatherproof material is canvas.

4. The weatherproof wheelchair cover system of claim 1 wherein said right viewing aperture, said left viewing aperture, said combination vent flap/upper viewing aperture, and said lower viewing aperture are made of a weatherproof transparent material.

5. The weatherproof wheelchair cover system of claim 1 wherein said at least one support frame is electrically controlled.

6. The weatherproof wheelchair cover system of claim 5 wherein said electrical control is powered by a motor.

7. The weatherproof wheelchair cover system of claim 6 wherein said motor uses the wheelchair's power source.

8. The weatherproof wheelchair cover system of claim 6 wherein said motor uses a separate power source.

9. The weatherproof wheelchair cover system of claim 6 wherein said motor uses a solar power source.

10. The weatherproof wheelchair cover system of claim 6 wherein said motor is activated using a joystick.

11. The weatherproof wheelchair cover system of claim 6 wherein said motor is activated using a button switch.

12. The weatherproof wheelchair cover system of claim 6 wherein said motor powers a cable spool and cable.

13. The weatherproof wheelchair cover system of claim 12 wherein said cable spool and cable deploy and retract said at least one support frame and said combination shield/cover.

14. The weatherproof wheelchair cover system of claim 1 wherein said attachment assembly comprises a motor/cable spool attachment member.

15. The weatherproof wheelchair cover system of claim 14 wherein said motor/cable spool attachment member serves as an attachment for said motor and said cable spool.

16. The weatherproof wheelchair cover system of claim 1 wherein said at least one support frame comprises a cable feed/frame coupler that further comprises a cable feed opening.

17. A weatherproof wheelchair cover system comprising:
a weatherproof wheelchair cover assembly comprising;
a combination shield/cover comprising:
a top surface;
a right side surface;
a left side surface;
a back surface;
a right viewing aperture comprising:
at least one support rib;
a left viewing aperture comprising:
at least one support rib;
a support frame sleeve;
a combination vent flap/upper viewing aperture comprising:
a hinged viewing aperture;
a first attachment hook and loop strap;
a second attachment hook and loop strap;
a lower viewing aperture;
an attachment assembly comprising:
a hinged attachment member;
a removably couplable attachment mechanism;
at least one support frame comprising:
a hinged attachment opening; and
a hinged pivot connector;
a second attachment hook and loop strap;
a lower viewing aperture;
an attachment assembly comprising:
a hinged attachment member;
a removably couplable attachment mechanism;
at least one support frame comprising:
a hinged attachment opening; and
a hinged pivot connector;
a joystick;
a motor/cable spool attachment member;
a motor;
a cable;
a cable feed/frame coupler comprising:
a cable feed opening; and
a cable spool.
wherein said weatherproof wheelchair cover system comprises said weatherproof wheelchair cover assembly;
wherein said weatherproof wheelchair cover assembly comprises said combination shield/cover, said attachment assembly, said at least one support frame, and plurality of hinged pivot connectors in functional combination;
wherein said combination shield/cover is defined by said top surface, said right side surface, said left side surface, said back surface; said right viewing aperture said left viewing aperture, said support frame sleeve, said combination vent flap/upper viewing aperture, said second attachment hook and loop strap, and said lower viewing aperture in functional combination;
wherein said combination vent flap/upper viewing aperture comprises said hinged viewing aperture and said first attachment hook and loop strap in functional combination;
wherein said attachment assembly comprises said hinged attachment member and said removably couplable attachment mechanism in functional combination;
wherein said top surface, said right side surface, said left side surface, and said back surface are to be constructed of a weatherproof material; wherein said weatherproof material is canvas;
wherein said right viewing aperture, said left viewing aperture, said combination vent flap/upper viewing aperture, and said lower viewing aperture are made of a weatherproof transparent material; wherein said at least one support frame is electrically controlled;
wherein said electrical control is powered by a motor;
wherein said motor uses the wheelchair's power source; and
wherein said motor is activated using a joystick.

18. The weatherproof wheelchair cover system of claim 17 further comprising a kit including: said weatherproof wheelchair assembly and a set of user instructions.

19. A method of using a weatherproof wheelchair cover system comprising the steps of:
obtaining said weatherproof wheelchair cover system;
mounting a weatherproof wheelchair cover assembly;
connecting said weatherproof wheelchair cover assembly; and
deploying said weatherproof wheelchair cover assembly.

20. The method of claim 19 further comprising the steps of:
retracting said weatherproof wheelchair cover assembly;
removing said weatherproof wheelchair cover assembly; and
storing said weatherproof wheelchair cover assembly.
